(19) United States
(12) Patent Application Publication
(10) Pub. No.: US 2011/0161095 A1
(43) Pub. Date: Jun. 30, 2011

(54) PERSONAL HEALTH MANAGEMENT SUITE

(75) Inventors: Christopher Alan Line, Barrington, IL (US); Stephen Anthony Fox, Barrington, IL (US); Eric Garland, Barrington, IL (US); Alejandro Rodriguez, Barrington, IL (US); Ryan Gross, Barrington, IL (US); Michael Mercado, Barrington, IL (US)

(73) Assignee: General Electric Company, Schenectady, NY (US)

(21) Appl. No.: 12/647,803

(22) Filed: Dec. 28, 2009

(51) Int. Cl. G06Q 50/00

(52) U.S. Cl. 705/2

(57) ABSTRACT

Certain examples provide a personal health management system including a data store, a processor, and a user interface. The data store is to store data related to patient health, the data store to store at least personal health record data for a patient. The processor is to gather and process data from the data store to determine a personalized plan of care for the patient using patient health data from the personal health record for the patient, patient preference information, and patient insurance information. The user interface is to display information related to the personalized plan of care for the patient and to facilitate user review and interaction with the displayed plan of care and the underlying patient health data.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Providers of medical services, whether as a hospital department or a stand alone group, find themselves in an increasingly competitive environment. Each provider is trying to capture profitable services to care for their patient populations. Medical service provider departments are often unaware of particular needs, habits, and circumstances of patients in their local markets.

### BRIEF SUMMARY

Certain examples provide systems and methods for analysis, management, and visualization of personal health data.

Certain examples provide a personal health management system including a data store, a processor, and a user interface. The data store is to store data related to patient health, the data store to store at least personal health record data for a patient. The processor is to gather and process data from the data store to determine a personalized plan of care for the patient, the processor using patient health data from the personal health record for the patient, patient preference information, and patient insurance information to generate the personalized plan of care for the patient, the processor providing decision support and personal health process automation for the patient in conjunction with the personalized plan of care for the patient and the patient's personal health data. The user interface is to display information related to the personalized plan of care for the patient and to facilitate user review and interaction with the displayed plan of care and the underlying patient health data. The user interface and the processor are to assist the patient to execute the personalized plan of care.

Certain examples provide a computer-implemented method for personal health management. The method includes gathering data related to a patient's health including at least personal health record data for the patient. The method also includes processing, using a processor, the data to determine a personalized plan of care for the patient based at least in part on the personal health record for the patient, patient preference information, and patient insurance information to generate the personalized plan of care for the patient. The method includes displaying, via a user interface, information related to the personalized plan of care for the patient and to facilitate user review and interaction with the displayed plan of care and the underlying patient health data. The method includes providing decision support and personal health process automation for the patient in conjunction with the personalized plan of care for the patient and the patient's personal health data to assist the patient to execute the personalized plan of care.

Certain examples provide a computer-readable storage medium having a set of instructions stored thereon which, when executed, instruct a personal health management system. The system includes a processor to gather and process data from a user's personal health record to determine a personalized plan of care for the user. The processor is to use patient health data from the personal health record for the user, user preference information, and user insurance information to generate the personalized plan of care for the user. The processor is to facilitate healthcare provider appointment scheduling and health account amount information for the user in connection with execution of the generated plan of care for the user. The system includes a user interface to display information related to the personalized plan of care for the user and to facilitate user review and interaction with the displayed plan of care and the underlying user health data. The user interface and the processor are to assist the user to execute the personalized plan of care.

### BRIEF DESCRIPTION OF SEVERAL VIEWS OF THE DRAWINGS

FIG. 1 illustrates an example Personal Health Record (PHR) Assistant system.

FIG. 2 illustrates an example system for plan of care construction.

FIG. 3 depicts an example home health planning system.

FIG. 4 shows a flow diagram for an example method for appointment booking.

FIG. 5 illustrates a flow diagram for an example method for health account estimation.

FIG. 6 illustrates a flow diagram for an example method for updated health account estimation.

FIG. 7 illustrates a flow diagram for an example method for determining a patient's wellness index.

FIG. 8 is a schematic diagram of an example processor platform that can be used and/or programmed to implement example systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain examples provide a personal health management system and associated method(s). Certain examples provide systems and methods to generate decision support and process automation for a patient based on patient personal health record data, for example.

As patients increasingly generate and own their own health records, patients become more involved in making their own health decisions. As a result, solutions are provided so that the patients can keep track of their health data. Rather than simply storing health data, disclosed systems and/or methods use patient health data to provide more meaningful information for the patient. By providing meaningful use of the data, disclosed systems and/or methods can provide incentives for the patient to use the systems and/or methods, increase the usability and usefulness of the systems and/or methods, and drive the marketability of the systems and/or methods, for example. Aggregation of a large amount of available medical data offers a potential for data mining through direct data gathering at the user level. By supplementing base statistics and algorithms with data from users, decision support can provide more meaningful suggestions to the user.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Certain examples provide a personal health record (PHR) assistant. The PHR Assistant provides a patient with decision support and process automation based on data existing in a patient's privately maintained personal health record. Using the patient's existing medical and insurance data, combined with direct input from the patient's clinicians and from the patient himself or herself, the PHR Assistant builds a care plan for the patient. The PHR Assistant system then helps the user determine the best way to execute that plan. For instance, the PHR Assistant system can help determine what kind of future medical expenses can be expected, what appointments must be set up, what activities may help the patient meet his or her goals, etc. Next, the PHR Assistant helps the user execute the plan, such as by interfacing with other systems, providing reminders to the patient, etc. At the same time, the PHR Assistant can track the patient's progress in executing the plan and provide the progress information to any interested parties, such as the patient and/or his or her family, insurance company, and/or caregivers.

In certain examples, the PHR Assistant system incorporates and/or accommodates one or more of finance and medical expenses; appointment booking; doctor/clinic quality reporting and recommendations; home physical therapy evaluations; nutrition/fitness goals, calculators, and/or planners; computerized examinations; wellness trending; etc. The PHR Assistant system allows the user to choose from one or more of these functions depending on his or her interests, needs, etc. The PHR Assistant accepts, as input, electronic medical data (e.g., stored within a patient's personal health record and/or taken from a provider-hosted data source). In addition, the system allows input from one or more clinicians. Where the data is incomplete, it can be supplemented through direct interaction with the user, for example. Physician input can include prescriptions, orders, and/or wellness goals for the patient, for example. Patient input can include planned elective medical treatments, over the counter medications, decisions related to the physician input, chronic health problems, long term goals, and/or responses to system prompted questions, for example. Analysis of data stored in the PHR includes the use of standard care protocols for the patient's medical problems, automated detection of preventative medicine measures that will be due for the patient, calculations about the probability that the patient will develop additional medical conditions, and/or other module-specific healthcare applications, for example. The input data and analysis are stored in the patient's PHR to build a care plan for the patient, for example.

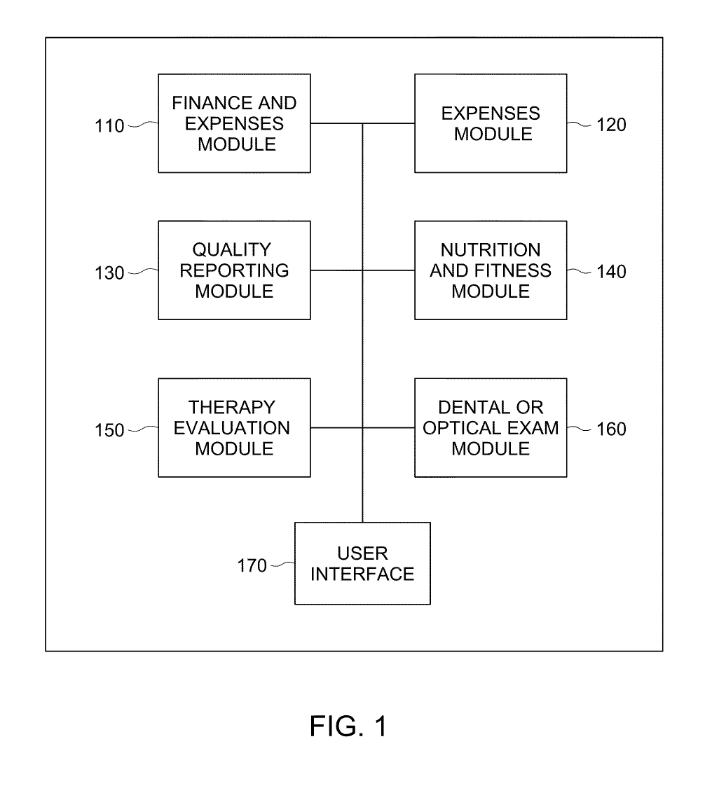

A PHR Assistant system can be implemented in the form of one or more modules, including a finance and medical expenses module, a scheduling module, a quality reporting module, a nutrition and fitness module, a therapy evaluation module, etc. As shown in FIG. 1, some examples of a PHR Assistant system 100 include a finance and medical expenses module 110, a scheduling module 120, a quality reporting module 130, a nutrition and fitness module 140, a therapy evaluation module 150, and/or a dental or optical examination module 160.

In some examples, the finance and medical expenses module 110 takes, as input, chronic disease information and a patient's care plan, information about the patient's insurance coverage (or lack thereof), and data on the average cost of the medical treatment near the patient. The system 100 combines this data to generate an itemized, personalized budget for the patient's medical expenses. The system 100 can apply algorithms to optimize the budget, based on patient preferences (e.g., lowest cost to the patient, highest quality of care, etc.). The system 100 can also provide an interface 170, which allows the user to directly edit the budget (e.g., make decisions about how to best execute the care plan). The system 100 can provide further feedback about how much money could be possibly placed into a Flexible Spending Account (FSA), for example, and the tax savings available through that account. The system 100 can also allow the user to opt for conservative, average, or liberal values for financial calculations. The system 100 can include the ability to view the cost in a best and worst case scenario.

For example, a family includes a husband with diabetes and a wife who is three months pregnant and has a genetic disposition for a high risk pregnancy. The finance and medical expenses module first looks at the medical details of everyone in the system, including their chronic diseases. The system 100, using the finance and medical expenses module 110, automatically calculates how much money it will cost for diabetes treatment based on number of visits, tests, and the amount of insulin someone the husband's age typically needs. The module 110 then calculates how much the remaining pregnancy will cost, and this cost is increased due to the wife's potential for high risk pregnancy that will incur more physician visits. The system 100 looks at the insurance information to calculate what is covered and how much a co-pay will be. Finally, the family chooses a conservative calculation because they would rather err on the side of not having enough money in the FSA than wasting that money. After the calculations have been completed, the system 100 presents a number representing how much money should be saved. The system 100 also shows an itemized list of what items are contributing to that cost.

In some examples, using a plan of care, the scheduling module 120 for the PHR Assistant system 100 is able to determine a type and number of appointments that are needed in a given period of time, and proactively schedule those appointments. The scheduling module 120 can take, as input, the patient's care plan, a list of preferred providers for each type of care, and, optionally, the patient's existing calendar, for example. The list of preferred providers can be manually entered, taken from the patient's insurance company, and/or taken from decisions made in other modules, for example. The scheduling module 120 can then use the plan of care to determine optimal and/or preferred dates to schedule appointments and finalize the schedule with the preferred provider for each service.

In some examples, the doctor/clinic quality reporting module 130 takes information from the PHR and combines it with a repository of quality metrics. The quality reporting module 130 then instructs the patient regarding which doctor and clinic would be preferred to visit based on the patient's medical history. The quality reporting module 130 can also instruct the patient regarding type of treatment and/or medication for which the patient should ask the doctor. Furthermore, the quality reporting module 130 can take the information being recorded in the PHR and submit it to a repository to create more accurate quality metrics.

In some examples, the nutrition and fitness module 140 can take as input existing medical condition(s) that affect diet (such as food allergies or diabetes) and/or physical capabilities (such as back problems or a sports injury) to generate restrictions on the patient's diet and/or physical activity. The user can also specify rules and/or restrictions, for example. Nutritional outputs can include diet suggestions (e.g., what foods to eat and when, where such foods can be located, what acceptable substitutes would be if the user does not desire to use such foods, etc.), for example. The fitness component of instructions and/or restrictions can specify a workout regimen tailored to the user's preferences and condition, for example.

While software exists that might make basic diet suggestions or help customize a user's workout, it is extremely difficult for people with special conditions or restrictions on their movement or diet to find the necessary workarounds. In some examples, the fitness and nutrition module 140 draws on the user's existing medical data to allow for more effective decision support that meets the user's needs without making unhelpful suggestions or requiring tedious customization.

In some examples, the home physical therapy evaluations module 150 provides an in-home rehabilitation self-assessment that allows for dynamic customization of a physical therapy regimen. The evaluations module 150 uses a combination of medical data automatically pulled from a PHR, user input of functional capacity results, and the patient's physical goals to design an accurate rehab plan/workout with an appropriate/necessary level of intensity, for example.

In some examples, the physical therapy module 150 allows the user to create an appropriate physical therapy regimen without the previous requirement of having to be under direct evaluation of a physical therapist. While not replacing a physical therapist, the therapy module 150 is to supplement the physical therapist's expertise when access to a physical therapist is not available or when a visit to a physical therapist is not necessary, for example. This gives the patient a reliable alternative for physical therapy guidance when the patient wants to make adjustments to their workout but does not feel it is necessary to schedule an appointment with a physical therapist and also, spend the money to visit a physical therapist. Using the therapy module 150, a user can customize a treatment plan for a particular patient, rather than using a generic workout that can apply to a classification of patients. Rather, the module 150 considers the patient's medical history, recent injuries/surgeries, functional capacity test results, and the patient's physical goals in order to generate a treatment plan that will maximize or improve a patient's progress. Additionally, the therapy module 150 educates the patient on what type of adjustments to make in their workout as their condition progresses throughout the treatment.

In some examples, results from self-diagnostic eye and dental exams can be used by a dental or optical examination module 160 the PHR Assistant system 100 to determine expected costs for the user to visit an optometrist and a dentist in the upcoming year. The PHR assistant system 100 can provide a user with a prioritized list of options for seeing an optometrist/dentist, depending on the self-diagnostic results, the amount of money the user is willing to pay, location, physician quality metrics, and/or other variables that are of interest to the user, for example. If the system 100 does not have eye or dental results, it can suggest self-diagnostic tools to the user. Along with the expected costs, the system 100 can report the criticality of seeing an optometrist/dentist based on self-diagnostic results (e.g., reporting can be implemented in the form of alerts and reminders). Since self-diagnostic tools may not be as accurate as those kept in-house by physicians, a certain confidence level can be associated with the criticality value.

In some examples, the dental or optical examination module 160 can be important for individuals who have not visited an optometrist/dentist lately, and are not aware of the risks involved with a lack of regular visits. The exam module 160 can also be important for those who cannot afford to see an optometrist/dentist too often.

In some examples, using a patient's personal data, the PHR Assistant system 100 can combine the user's personal goals, quality of life criteria, etc., to provide an outlook of the user's current trend of health versus a prediction of the user's health in the future. This can be socially compared to other persons with the same or similar data and/or goals to present the user with recommendations regarding things to change, stop doing, or alter to re-align his or her current health trend with a target wellness trend. Recommendations can include, but are not limited to, fitness, diet, medical treatment, personal habit, change in doctor, increase in frequency of doctor visit, recommendation to get a physical, colonoscopy, etc. A wellness trend can display information about a user including, but not limited to, financial opportunities of improvement, financial comparing of recommendations, length of life comparing recommendations, quality of life comparing recommendations, probability of chronic disease, comparative view of wellness trend of others, etc.

One or more of the PHR Assistant modules 110-160 can solve several problems, including but not limited to the following. For example, patients are provided with Flexible Spending Accounts, which they can use to pay for medical expenses. However, the money that the patient puts into this account is lost if it is not spent during a given year. This creates a risk that causes some patients to avoid using these accounts despite the benefits associated with the FSAs. This extends to patients who have little history with having to plan a medical budget. Healthcare costs can be very difficult for a patient to understand. By automating the generation of a health budget, the PHR Assistant 100 helps consumers understand what options are available to reduce their costs while maintaining their health.

Previously, it was difficult for patients to remember to make all of the appointments that are necessary to optimally maintain their health. By automatically determining what type of appointments may be necessary and automatically interfacing with clinical scheduling systems, the PHR Assistant 100 helps eliminate the extra effort required to make these appointments.

Using prior systems and methods, it was difficult for caregivers to know if a patient was complying with, modifying, or ignoring his or her plan of care between visits. There is little immediate incentive for patients to provide this information, and caregivers do not have the time to collect it. Using the PHR Assistant 100, the need for manual data gathering can be reduced or eliminated by providing progress information entered by the patient to the clinician (e.g., either through electronic transfer or a printed report) and providing the patient with an incentive to track his or her performance through instantaneous feedback, and tweaks to the plan of care.

Patients often lack sufficient feedback to understand the overall impact of some of their personal health decisions. By providing medical decision suggestions based on statistics and wellness trending, one or more modules of the PHR Assistant suite 100, via the user interface 170, show patients how their quality of life can be improved.

Wellness trending offers quantifiable information to a patient about how certain factors of life (such as healthcare costs, life span, etc.) can be improved by certain health-related decisions. Certain examples analyze current health trends in order to provide recommendations and assistance toward reaching long-term quality of life goals, for example.

In some examples, rather than simply storing health data, the system 100 uses that data to provide more meaningful information for the patient. By providing meaningful use of the data, the system 100 provides incentives for the patient to use the system 100, increase the usability and usefulness of the system 100, and drive the marketability of the system 100, for example. The system 100 can aggregate a large amount of available medical data to facilitate data mining through direct data gathering at the user level. By supplementing the base statistics and algorithms used by the system 1—with data from users, decision support provided by the system 100 can offer more meaningful suggestions to the user. Patient support can be offered in a wide variety of areas, such as financing, scheduling, physical therapy, etc.

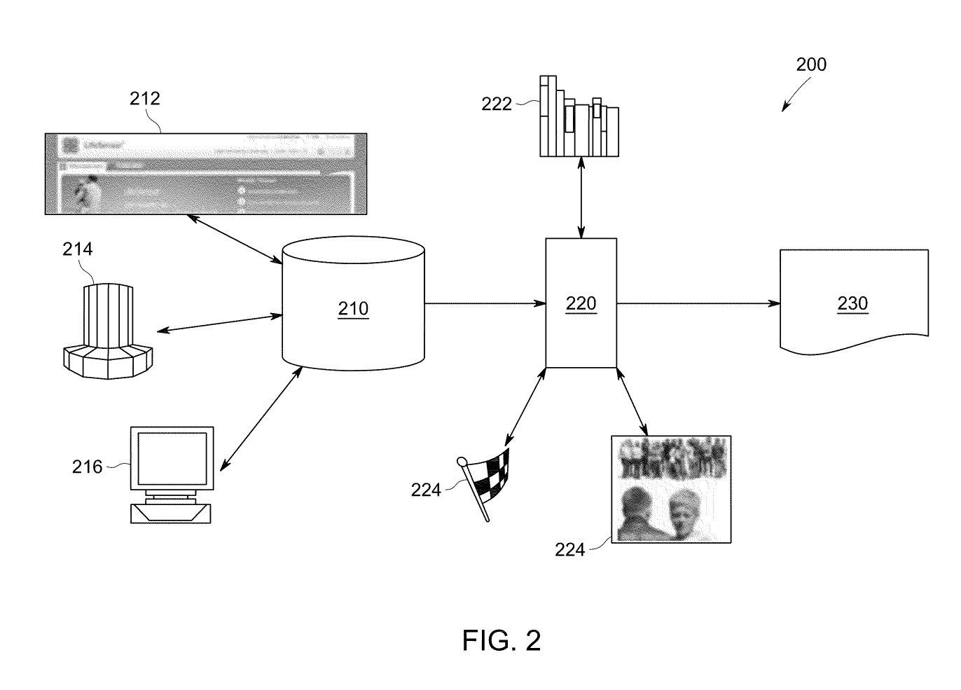

FIG. 2 illustrates an example system 200 for plan of care construction. The system 200 includes a data gatherer 210 and a data processor 220 that produce a plan of care 230. The data gatherer 210 receives and/or retrieves information from one or more electronic health data sources, such as a PHR 212, health information organization (HIO) 214, electronic health record (EHR) 216, etc. Data received can be related to a particular patient, for example. Gathered data can be stored in the data gatherer 210 and/or aggregated and passed through to the data processor 220.

The data processor 220 receives data from the data gatherer 210. The data processor 220 also receives information from medical guidelines 222, patient goals 224, and/or other similar patient information 226, for example. Based on the received data, the data processor 220 generates a plan of care 230 for a particular patient. In some examples, the data processor 220 can provide decision support along with the care plan 230 to help the patient determine the best (or at least a better) way to execute the plan of care 230. For example, the data processor 220 can use information from one or more of the data sources 210, 212, 214, 216, 222, 224, and/or 226 in the system 200 to help determine what kind of future medical expenses can be expected, what appointments must be set up, what activities may help the patient meet his or her goals, etc. The system 200 can also help and/or facilitate the user execute the plan 230, such as by interfacing with other systems, providing reminders to the patient, etc. The system 200 can also track the patient's progress in executing the plan 230 and provide progress information to one or more data stores and/or systems, such as the PHR 212, HIO (or regional HIO) 214, EHR 216, EMR, insurance database/system, and/or caregiver system.

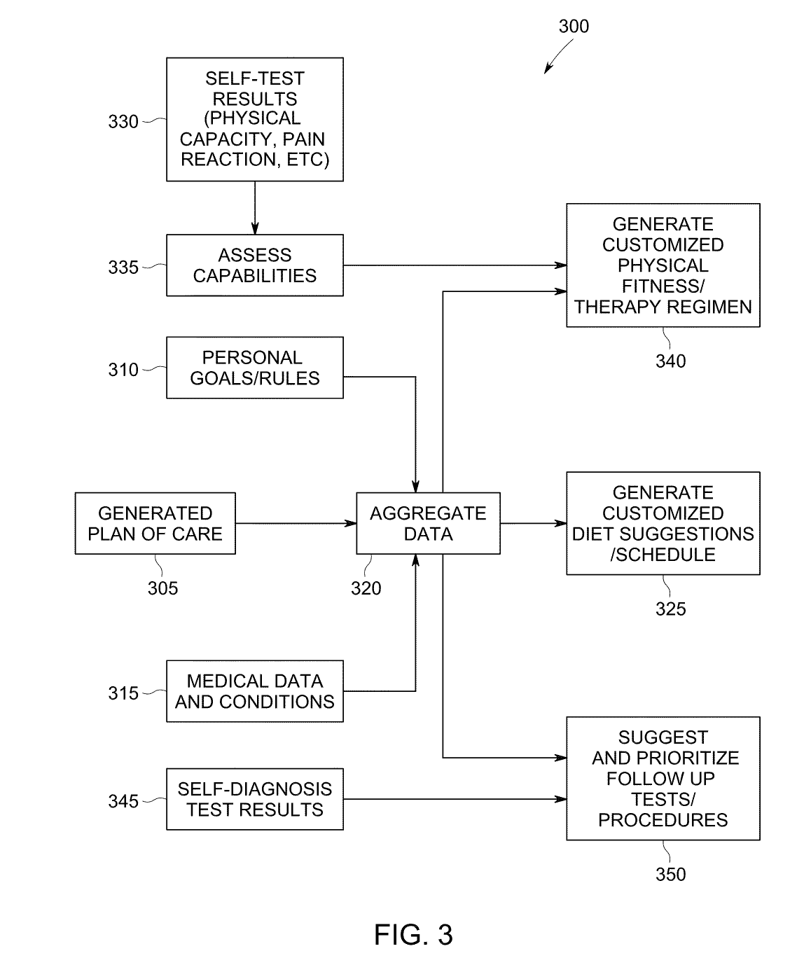

FIG. 3 depicts an example home health planning system 300. The system includes a generated plan of care 305 (such as the plan of care 230), a data aggregator 320, and one or more outcomes generators 325, 340, 350. The data aggregator 320 receives the plan of care 305 generated for a patient and additional information such as personal goals/rules 310 for the patient, medical data and conditions 315 for the patient, etc. Using the plan of care 305, rules 310, and patient data 315, the data aggregator 320 generates aggregated patient data for use by the one or more outcomes generators 325, 340, 350, for example.

For example, a custom diet generator 325 generates customized diet suggestions, a diet schedule, and/or other patient diet guidelines, recommendations, etc. Generated output from the diet generator 325 can be provided to an electronic data storage (e.g., a PHR, EHR, EMR, HIO, etc.), transmitted via facsimile to a patient and/or healthcare provider, printed for a patient, etc.

The system 300 can include a fitness/therapy regimen generator 340 that accepts aggregated patient/care plan data as well as patient capability assessment information generated by the patient capability assessor 335 in response to one or more patient self-test results 330 (e.g., physical capacity, pain reaction, etc.) performed on and/or by the patient. A physical fitness and/or therapy regimen can be used in conjunction with the care plan 305 to treat, rehabilitate, and/or keep fit the patient, for example. Generated output from the regimen generator 340 can be provided to an electronic data storage (e.g., a PHR, EHR, EMR, HIO, etc.), transmitted via facsimile to a patient and/or healthcare provider, printed for a patient, etc.

The system 300 can include a follow-up generator 350 that accept aggregated patient/care plan data as well as patient self-diagnosis test results and/or information generated by the patient self-diagnosis 345 performed on and/or by the patient. A suggestion of follow-up tests, procedures, examinations, etc. can be used in conjunction with the care plan 305 to treat, rehabilitate, and/or keep fit the patient, for example. In some examples, suggestions can be prioritized based on one or more criteria such as criticality, patient condition, cost, etc. Generated output from the follow-up generator 350 can be provided to an electronic data storage (e.g., a PHR, EHR, EMR, HIO, etc.), transmitted via facsimile to a patient and/or healthcare provider, printed for a patient, etc.

A patient plan of care and/or other supporting information can be used to facilitate treatment, follow-up, and/or subsequent diagnosis of a patient. Such information can be used by the patient to proactively manage his or her health, for example.

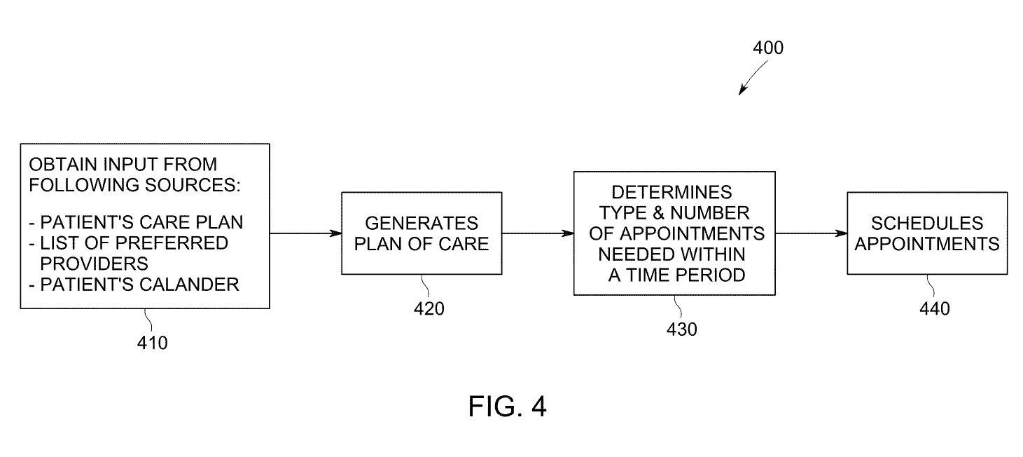

FIG. 4 shows a flow diagram for an example method 400 for appointment booking. At block 410, patient health input is obtained from one or more sources including a patient care plan, a list of preferred providers for the patient, a patient calendar/schedule, etc. Then, at block 420, a plan or care is generated and/or updated based on the information obtained at block 410. At block 430, a type and number of appointments is determined within a certain time period based on the plan of care information. For example, based on patient condition, treatment regimen, and available providers involved in the treatment regimen, a number and type of appointments needed within the next six months can be determined for the patient. At block 440, one or more appointments are scheduled based at least in part on the determination, the plan of care, provider and/or patient insurance information, etc.

As described herein, the method 400 can be implemented in one or more combinations of hardware, software, and/or firmware, for example. The method 400 can operate in conjunction with one or more external systems (e.g., data sources, healthcare information systems (PHR, EHR, EMR, HIO, RHIO, RIS, PACS, CVIS, HIS, etc.), archives, imaging modalities, etc.). One or more components of the method 400 can be reordered, eliminated, and/or repeated based on a particular implementation, for example. The method 400 can be implemented using a stationary (e.g., desktop workstation, laptop computer, etc.) and/or mobile device (e.g., smartphone, tablet computer, etc.), for example.

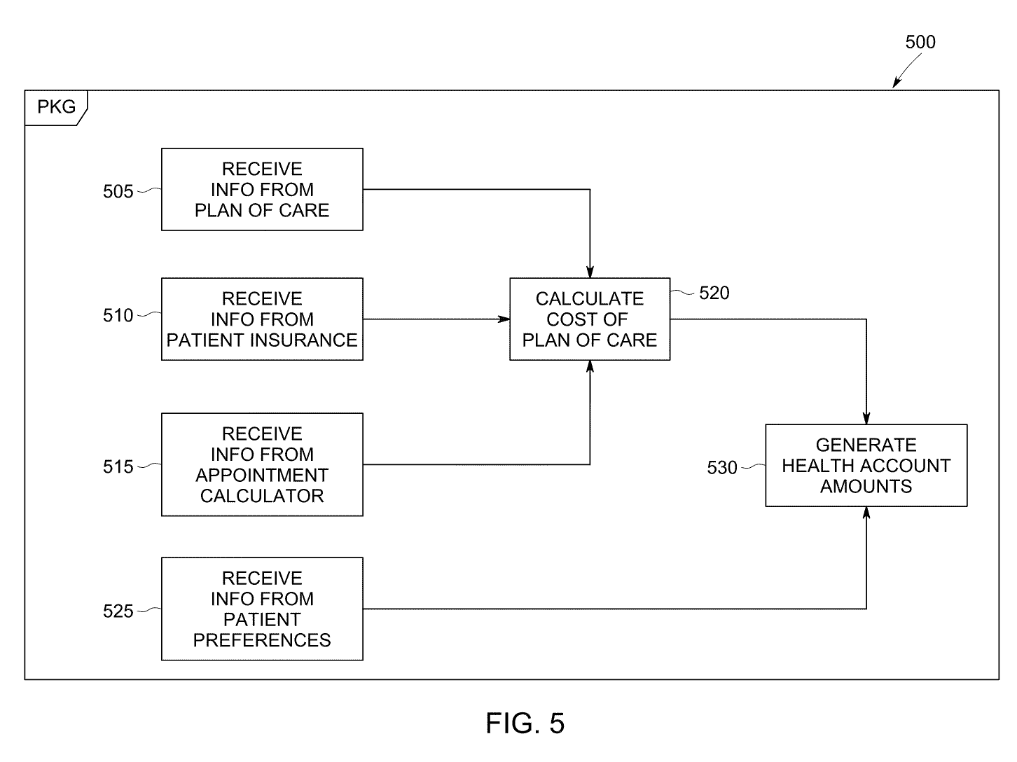

FIG. 5 illustrates a flow diagram for an example method 500 for health account estimation. At block 505, information is received from a patient's plan of care. At block 510, information is received from a patient insurance provider. At block 515, information is received from a patient and/or provider appointment calendar/schedule. At block 520, a cost of the patient's plan of care is calculated based on the received information regarding care plan, patient insurance coverage, scheduled patient appointments with one or more healthcare providers, etc. At block 525, information regarding patient preferences is received. Patient preference information is combined with calculated care plan cost and, at block 530, health account (e.g., Flexible Spending Account, Health Savings Account, Medical Savings Account, etc.) amount(s) are generated. For example, health account amounts are generated to cover a patient's care plan while accommodating patient preferences (e.g., physician, procedure, location, etc.).

As described herein, the method 500 can be implemented in one or more combinations of hardware, software, and/or firmware, for example. The method 500 can operate in conjunction with one or more external systems (e.g., data sources, healthcare information systems (PHR, EHR, EMR, HIO, RHIO, RIS, PACS, CVIS, HIS, etc.), archives, imaging modalities, etc.). One or more components of the method 500 can be reordered, eliminated, and/or repeated based on a particular implementation, for example. The method 500 can be implemented using a stationary (e.g., desktop workstation, laptop computer, etc.) and/or mobile device (e.g., smartphone, tablet computer, etc.), for example.

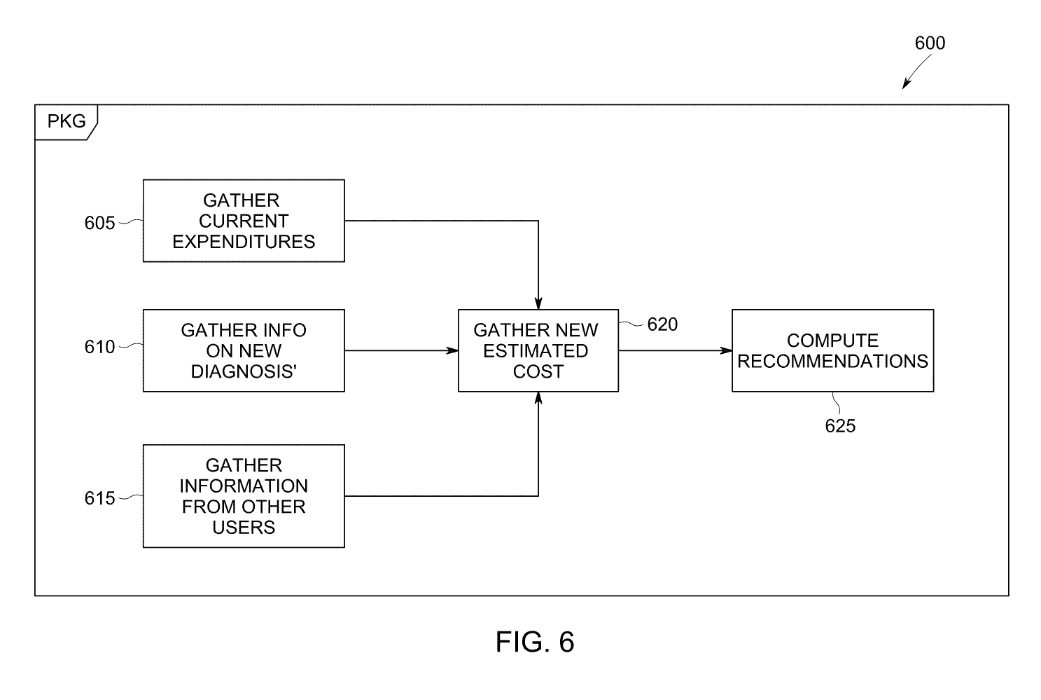

FIG. 6 illustrates a flow diagram for an example method 600 for updated health account estimation. At block 605, a patient's current health expenditures (e.g., doctor visits, exams, labs, prescriptions, therapy, etc.) are gathered. At block 610, information regarding a new diagnosis for the patient is gathered. At block 615, information from other users with similar conditions is gathered. In some examples, authorization and/or other approval from one or more of the other users may be necessary before the information can be used for the present patient. In some examples, other patient data can be anonymized to allow its data mining and use for the present patient. At block 620, patient current expenditures, new/updated diagnosis, and similar user information are used to generate a new estimated cost. At block 630, one or more recommendations are computed for the patient. For example, one or more recommendations regarding treatment options, follow-up actions, therapy, provider(s), prescription options, accounts, spending plans, schedule/timetable, etc., can be generated and provided to a user, stored, and/or routed to one or more other systems to allocate funds, schedule appointments, authorize actions, etc.

As described herein, the method 600 can be implemented in one or more combinations of hardware, software, and/or firmware, for example. The method 600 can operate in conjunction with one or more external systems (e.g., data sources, healthcare information systems (PHR, EHR, EMR, HIO, RHIO, RIS, PACS, CVIS, HIS, etc.), archives, imaging modalities, etc.). One or more components of the method 600 can be reordered, eliminated, and/or repeated based on a particular implementation, for example. The method 600 can be implemented using a stationary (e.g., desktop workstation, laptop computer, etc.) and/or mobile device (e.g., smartphone, tablet computer, etc.), for example.

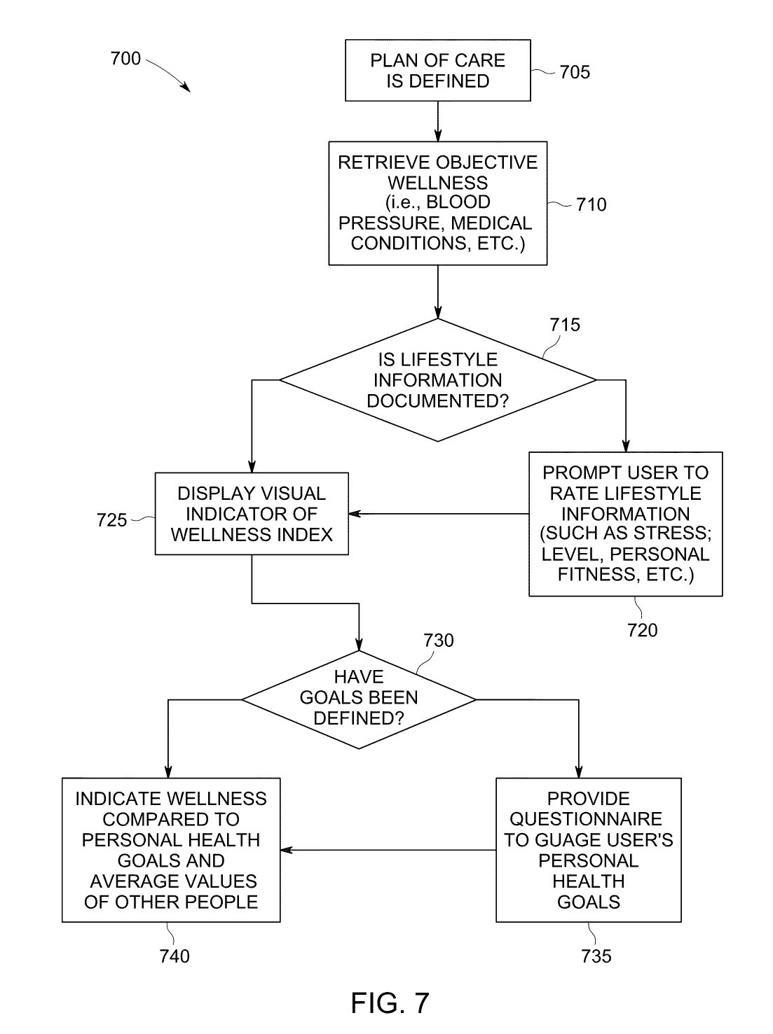

FIG. 7 illustrates a flow diagram for an example method 700 for determining a patient's wellness index. At block 705, a plan of care is defined. For example, a series of recommended actions (e.g., physician visit, imaging exam, exercise regimen, diet plan, etc.) is generated for a patient based on available information.

At block 710, object wellness information is retrieved. For example, patient blood pressure, weight, existing medical condition(s), etc., is retrieved from one or more sensors and/or information storage systems (PHR, EHR, EMR, HIO, RHIO, RIS, PACS, CVIS, HIS, etc.).

At block 715, available information is reviewed to determine whether patient lifestyle information is documented. If not, at block 720, the user is prompted to rate and/or otherwise provide lifestyle information such as stress level, personal fitness, etc. At block 725, using patient object wellness information and lifestyle information, a visual indicator of a patient wellness index is generated and displayed. For example, information can be transformed (e.g., according to one or more algorithms with or without relative weights given to certain factors) into a wellness index for the patient. The wellness index can be graphically displayed as a line on a graph or reference scale, color-coded indicator, selectable measure of wellness, and/or other static and/or interactive graphical indicator, for example.

At block 730, patient information is examined to determine if patient health goals have been defined. If not, at block 735, a questionnaire (e.g., printed and/or electronic (e.g., Web-based)) is provided to the patient to gauge the user's personal health goals. At block 740, the wellness index is compared to the patient's personal health goals, and an indicator of the comparison is provided. The indicator can be provided visually as a graphical indicator and/or output as data for storage and/or routing to another clinical program, for example. In some examples, the patient's wellness index can be compared to average wellness values for other people as well as to the patient's personal health goals to determine the comparison indicator.

As described herein, the method 700 can be implemented in one or more combinations of hardware, software, and/or firmware, for example. The method 700 can operate in conjunction with one or more external systems (e.g., data sources, healthcare information systems (PHR, EHR, EMR, HIO, RHIO, RIS, PACS, CVIS, HIS, etc.), archives, imaging modalities, etc.). One or more components of the method 700 can be reordered, eliminated, and/or repeated based on a particular implementation, for example. The method 700 can be implemented using a stationary (e.g., desktop workstation, laptop computer, etc.) and/or mobile device (e.g., smartphone, tablet computer, etc.), for example.

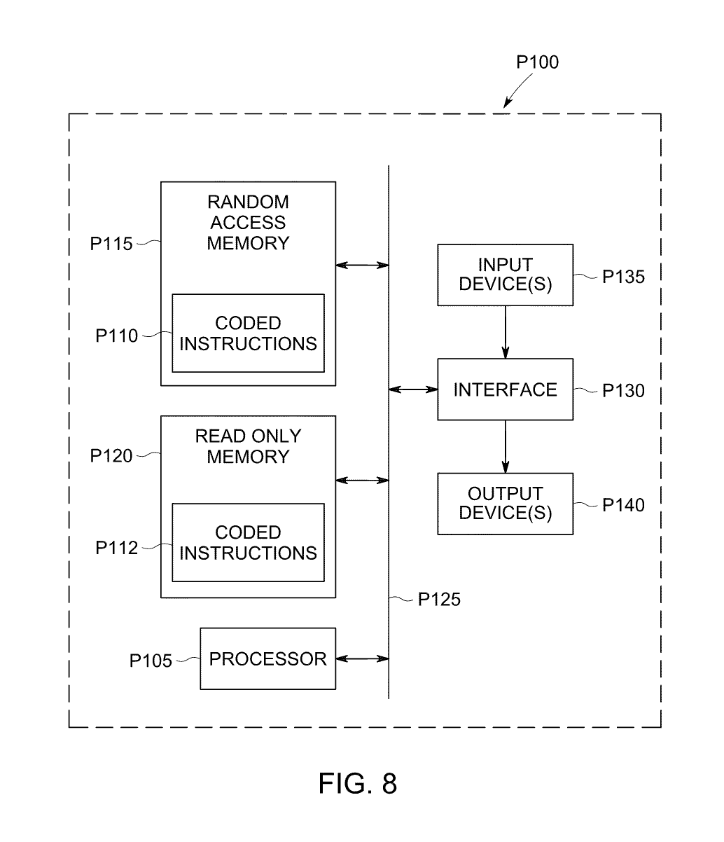

FIG. 8 is a schematic diagram of an example processor platform P100 that can be used and/or programmed to implement the example systems and methods described above. For example, the processor platform P100 can be implemented by one or more general-purpose processors, processor cores, microcontrollers, etc.

The processor platform P100 of the example of FIG. 8 includes at least one general-purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example processes of FIGS. 2-7 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown). The example memory P115 may be used to implement the example databases described herein.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The input devices P135 may be used to, for example, receive patient documents from a remote server and/or database. The example output devices P140 may be used to, for example, provide patient documents for review and/or storage at a remote server and/or database.

While an example manner of implementing the systems 100, 200, 300 of FIGS. 1-3 has been illustrated, one or more of the elements, processes and/or devices illustrated in FIGS. 1-3 can be combined, divided, re-arranged, omitted, eliminated and/or implemented in any other way. Further, the elements or components of systems 100, 200, 300 can be implemented by hardware, software, firmware and/or any combination of hardware, software and/or firmware. Thus, for example, one or more of the elements of systems 100, 200, 300 of FIGS. 1-3 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the elements of the systems 100, 200, 300 of FIGS. 1-3 is hereby expressly defined to include a tangible medium such as a memory, DVD, CD, etc., storing the software and/or firmware. Further still, one or more of the elements of the systems 100, 200, 300, can include one or more elements, processes and/or devices in addition to, or instead of, those illustrated in FIGS. 1-3, and/or can include more than one of any or all of the illustrated elements, processes and devices.

The example processes of FIGS. 3-7 may be performed using a processor, a controller and/or any other suitable processing device. For example, the example processes of FIGS. 3-7 may be implemented in coded instructions stored on a tangible medium such as a flash memory, a read-only memory (ROM) and/or random-access memory (RAM) associated with a processor (e.g., the example processor P105 discussed below in connection with FIG. 8). Alternatively, some or all of the example processes of FIGS. 3-7 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3-7 may be implemented manually or as any combination(s) of any of the foregoing techniques, for example, any combination of firmware, software, discrete logic and/or hardware. Further, although the example processes of FIGS. 3-7 are described with reference to the flow diagrams of FIGS. 3-7, other methods of implementing the processes of FIGS. 3-7 may be employed. For example, the order of execution of the blocks may be changed, and/or some of the blocks described may be changed, eliminated, sub-divided, or combined. Additionally, any or all of the example processes of FIGS. 3-7 may be performed sequentially and/or in parallel by, for example, separate processing threads, processors, devices, discrete logic, circuits, etc.

Certain examples allow a user to solve basic personal health management problems by providing decision support based on existing data. Certain examples bring together a number of healthcare-related applications to determine a comprehensive plan of care for the patient. Certain examples interface directly with a user's medical data and simply patient workflow by reducing the amount of user input necessary to provide decision support mechanisms. Certain examples facilitate scheduling, cost estimation, and planning to execute a generated plan of care for a patient.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A personal health management system, the system comprising:
a data store to store data related to patient health, the data store to store at least personal health record data for a patient;
a processor to gather and process data from the data store to determine a personalized plan of care for the patient, the processor to use patient health data from the personal health record for the patient, patient preference information, and patient insurance information to generate the personalized plan of care for the patient, the processor to provide decision support and personal health process automation for the patient in conjunction with the personalized plan of care for the patient and the patient's personal health data; and
a user interface to display information related to the personalized plan of care for the patient and to facilitate user review and interaction with the displayed plan of care and the underlying patient health data, the user interface and the processor to assist the patient to execute the personalized plan of care.

2. The system of claim 1, wherein the processor and the user interface are to facilitate healthcare provider appointment scheduling in connection with execution of the generated plan of care for the patient.

3. The system of claim 1, wherein the processor is to generate a cost estimation associated with at least a portion of the execution of the generated plan of care for the patient.

4. The system of claim 1, wherein the processor is to facilitate obtaining objective wellness information for the patient.

5. The system of claim 4, wherein the processor is to generate a wellness index for the patient based on objective wellness information and patient lifestyle information.

6. The system of claim 5, wherein the processor is to generate a graphical representation of the wellness index for display to the user via the user interface.

7. The system of claim 5, wherein the processor is to compare the patient wellness index to stored personal health goals for the patient.

8. The system of claim 7, wherein the processor is to compare patient wellness index to average wellness index values for other people.

9. The system of claim 1, wherein the data is to store data from one or more of an electronic health record, an electronic medical record, and a health information organization.

10. The system of claim 1, further comprising a finance and medical expenses module, a scheduling module, a quality reporting module, a nutrition and fitness module, a therapy evaluation module, and a dental or optical examination module to work in conjunction with the processor.

11. A computer-implemented method for personal health management, the method comprising:
gathering data related to a patient's health including at least personal health record data for the patient;
processing, using a processor, the data to determine a personalized plan of care for the patient based at least in part on the personal health record for the patient, patient preference information, and patient insurance information to generate the personalized plan of care for the patient,
displaying, via a user interface, information related to the personalized plan of care for the patient and to facilitate user review and interaction with the displayed plan of care and the underlying patient health data; and
providing decision support and personal health process automation for the patient in conjunction with the personalized plan of care for the patient and the patient's personal health data to assist the patient to executed the personalized plan of care.

12. The method of claim 11, further comprising scheduling, one or more healthcare provider appointments in connection with execution of the generated plan of care for the patient.

13. The method of claim 11, further comprising generating a cost estimation associated with at least a portion of the execution of the generated plan of care for the patient.

14. The method of claim 13, further comprising updating the cost estimation based at least in part on a new diagnosis for the patient.

15. The method of claim 11, further comprising obtaining objective wellness information for the patient.

16. The method of claim 15, further comprising generating a wellness index for the patient based on objective wellness information and patient lifestyle information.

17. The method of claim 16, further comprising generating a graphical representation of the wellness index for display via the user interface.

18. The method of claim 16, further comprising comparing the patient wellness index to stored personal health goals for the patient.

19. The method of claim 18, further comprising comparing patient wellness index to average wellness index values for other people.

20. A computer-readable storage medium having a set of instructions stored thereon which, when executed, instruct a personal health management system, the system comprising:
a processor to gather and process data from a user's personal health record to determine a personalized plan of care for the user, the processor to use patient health data from the personal health record for the user, user preference information, and user insurance information to generate the personalized plan of care for the user, the processor to facilitate healthcare provider appointment scheduling and health account amount information for the user in connection with execution of the generated plan of care for the user; and
a user interface to display information related to the personalized plan of care for the user and to facilitate user review and interaction with the displayed plan of care and the underlying user health data, the user interface and the processor to assist the user to executed the personalized plan of care.

21. The computer readable storage medium of claim 20, wherein the processor is to generate a wellness index for the user based on objective user wellness information and user lifestyle information, wherein the wellness index is graphically represented for display to the user via the user interface and wherein the user wellness index is compared to at least one of stored personal health goals for the user and an average wellness index value for one or more other persons.
